(19) United States
(12) Patent Application Publication
(10) Pub. No.: US 2005/0151632 A1
(43) Pub. Date: Jul. 14, 2005

(54) Unit for sensing obstacles in the vicinity of vehicles

(75) Inventor: Giuseppe Simonazzi, Reggio Emilia (IT)

Correspondence Address: MODIANO & ASSOCIATI, Via Meravigli, 16, MILANO, 20123, IT

(73) Assignee: META SYSTEM- S.P.A.

(21) Appl. No.: 10/855,330

(22) Filed: May 28, 2004

(30) Foreign Application Priority Data
Jan. 13, 2004 (IT) MO2004A000005

(51) Int. Cl. B60Q 1/00

(52) U.S. Cl. 340/436

(57) ABSTRACT

A unit for sensing obstacles in the vicinity of vehicles, comprising at least one support, which can be associated with the body of a vehicle, and an obstacle sensing device, which can be connected to a processing unit by way of the interposition of electronic transmission elements, the support comprising elements for the electronic connection of the sensing device to the transmission elements.

### BACKGROUND OF THE INVENTION

It is known that many vehicles can be equipped with safety, alarm or control instruments that are suitable to indicate the distance of said vehicle from external objects located in the vicinity, allowing the driver to maneuver safely without the danger of collisions or impacts even in low-visibility conditions.

Traditionally, these instruments are provided with sensing devices, such as for example transducers, microcameras or the like, which are capable of sensing obstacles that are present in their vicinity and of then sending an electronic signal, over conducting cables, to a processing unit, such as for example conventional electronic control units for cars.

These devices are commonly applied to cars at their bumpers, which are more exposed to the risk of collision with external objects: in particular, the sensing devices are arranged on conveniently shaped supports, such as brackets, lugs or the like, which are permanently or detachably connected to the internal surface of the bumper.

Traditionally, devices fitted on such supports have a surface that is adapted to locate the obstacles, which is oriented outward, for example through an opening formed in the bumper, and a port for connection to the processing unit and/or to a power supply, which instead is directed toward the inside of the vehicle so that it can be accessed by the operator who performs its electrical connection.

Fitting the sensing devices to the bumper, in particular, provides for a first operation to apply said devices to the supports and then a second wiring operation, by means of which each connection port is placed in contact with the conducting cables.

These conventional devices are not free from drawbacks, including the fact that said assembly step is rather complicated, since it requires many repetitive operations that require significant execution times.

It is noted in this regard that safety, alarm or control instruments, in order to be particularly efficient and functional, may provide for the presence of many sensing devices, each of which has to be fitted on the corresponding support and then connected electrically.

Moreover, it is noted that vehicle manufacturers increasingly rely on subcontractors to provide the components, and merely perform assembly in their factories; accordingly, such assembly becomes particularly important, since if it is not sufficiently quick and economical it may penalize said manufacturers considerably.

### SUMMARY OF THE INVENTION

The aim of the present invention is to eliminate the above-mentioned drawbacks of the known art, by providing a unit for sensing obstacles in the vicinity of vehicles that allows to simplify and facilitate the task of the operator assigned to assembly and also reduces considerably the time required to perform the corresponding operations, allowing to increase the production capacity of the workforce and to reduce its cost.

Within this aim, an object of the present invention is to provide a unit that is simple, relatively easy to provide in practice, safe in use, effective in operation, and has a relatively low cost.

This aim and this and other objects that will become better apparent hereinafter are achieved by the present unit for sensing obstacles in the vicinity of vehicles according to the invention, comprising at least one support, which can be associated with the body of a vehicle and is adapted to support at least one obstacle sensing device, which can be connected to a processing unit by way of the interposition of electronic transmission means, characterized in that said support comprises means for the electronic connection of said sensing device to said transmission means.

### BRIEF DESCRIPTION OF THE DRAWINGS

Further characteristics and advantages of the present invention will become better apparent from the following detailed description of a preferred but not exclusive embodiment of a unit for sensing obstacles in the vicinity of vehicles, illustrated by way of non-limiting example in the accompanying drawings, wherein:

FIG. 1 is a perspective view of a possible embodiment of the unit according to the invention;

FIG. 2 is a partial perspective view of the unit of FIG. 1;

FIG. 3 is a partially cutout perspective view of the sensing device of the unit of FIG. 1;

FIG. 4 is a perspective view, taken from another angle, of the device of FIG. 3;

FIG. 5 is a partial perspective view of an alternative embodiment of the unit according to the invention.

### DESCRIPTION OF THE PREFERRED EMBODIMENTS

With reference to the figures, the reference numeral 1 generally designates a unit for sensing obstacles in the vicinity of vehicles.

The unit 1 is provided with a plurality of supports 2 for corresponding sensing devices 3, used to identify and locate obstacles and objects located outside a vehicle.

In particular, the supports 2 are associated with the vehicle body; preferably, they can be distributed along the front or rear bumper of a car, but alternative embodiments of the present invention, in which said supports are located differently, are not excluded.

The bumper of the vehicle is not shown in the figures because it is of a conventional type.

Each support 2 has a plate 4, which can be associated with the internal surface of the bumper detachably, for example by interposing anchoring means of the snap-action type, of the threaded type, or the like, or permanently, by way of gluing, welding or other processes.

As an alternative, the supports 2 can be built into the bumper and constitute a single body therewith; in this embodiment of the invention, the plate 4 of each support 2 is formed by at least one portion of said bumper.

Each device 3 has a substantially cylindrical portion 5, at the base surface of which obstacle sensing means 6 are provided.

Conveniently, the means 6 are constituted by sensors, transducers, microcameras, or the like, particularly by an ultrasonic sensor.

Advantageously, on the bumper of the vehicle there are a plurality of first circular through openings, and each plate 4 is provided with a second likewise circular through opening 7, which is suitable to be arranged so as to substantially mate with one of the first openings in order to allow to insert the portion 5 of the corresponding device 3 in an assembly configuration, in which the sensor 6 is arranged so that it faces outward.

To facilitate the arrangement of the devices 3 with respect to the second openings 7, each support 2 is provided with a hollow cylinder 8, which protrudes at right angles to the plate 4 around the corresponding second opening 7 and from which two tabs 8a protrude axially; the dimensions of the hollow cylinder are such as to allow the snug insertion of the portion 5.

The devices 3 can be connected to a central processing unit, such as the control unit of the vehicle, which is not shown in the figures because it is of a conventional type, by way of electronic transmission means, such as conducting cables 9.

According to the invention, each one of the supports 2 is provided with electronic connection means 10, by way of which it is possible to connect the corresponding device 3 to the conducting cables 9.

Conveniently, such connection means comprise a circuit 11, which is associated with the conducting cables 9 and is suitable, in the assembly configuration, to be arranged so that it is connected to a connection port P with which the device 3 is equipped in order to transmit the output signal and/or be supplied with power.

Advantageously, the connection port P and the portion 5 of each device 3 are both oriented toward the plate 4; each device 3 is in fact provided with a tubular portion 12, which is laterally associated parallel to the portion 5, is open at the end that is adjacent to the sensor 6, and contains a cavity 13 onto which the connection port P opens.

In practice, such tubular portion allows the connection means 10 of each support 2 to access the connection port P, so that the insertion of the device 3 in the respective hollow cylinder 8 is suitable to couple the port to the corresponding circuit 11 and from there to the conducting cables 9 and to the central unit.

The connection means 10 of each support 2 comprise an elongated body 14, which protrudes from the surface of the plate 4 that lies opposite the bumper substantially at right angles to said plate.

The distance between the body 14 and the hollow cylinder 8 of each support 2 is substantially equal to the distance between the portion 5 and the tubular portion 12 of the respective device 3, so that in the assembly configuration the body 14 is inserted in the cavity 13 until it reaches the connection port P.

The unit 1 according to the invention further comprises, for each one of the devices 3, a conventional electronic board S for processing the signal acquired by the corresponding sensor 6; the board is interposed between said sensor and the circuit 11.

In practice, the boards are designed to convert the analog signal that arrives from the sensors 6 into a digital signal suitable to be transmitted to the central unit and/or to supply said sensors with the power supply current required for their operation, as is known in the background art.

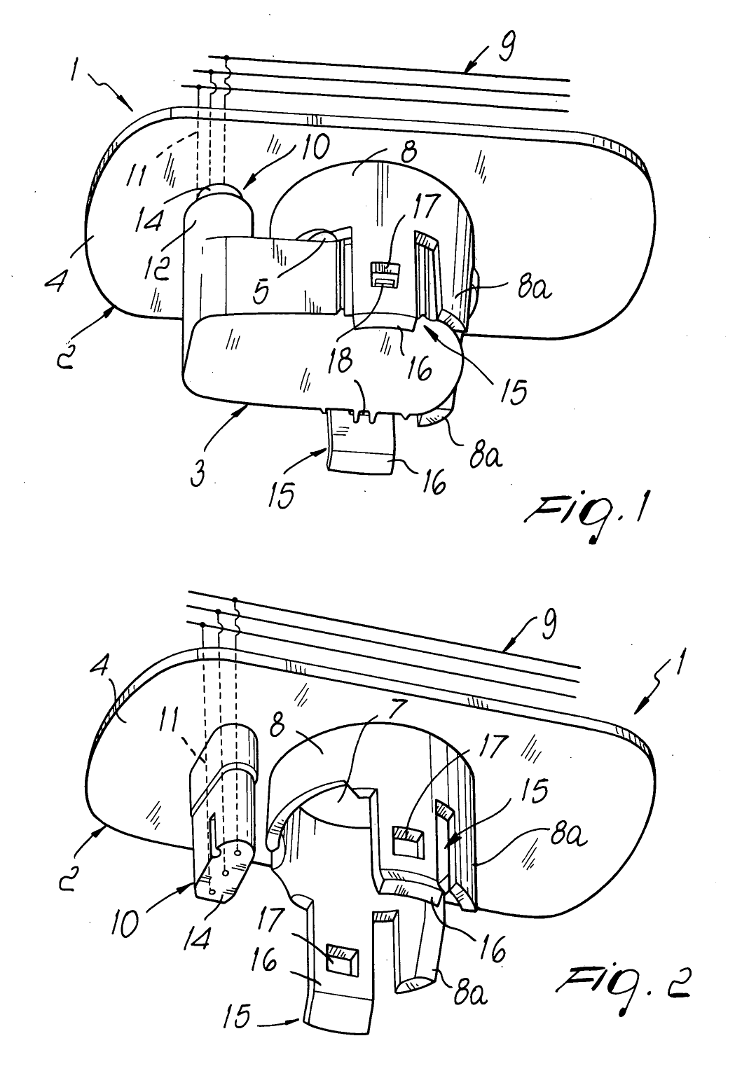

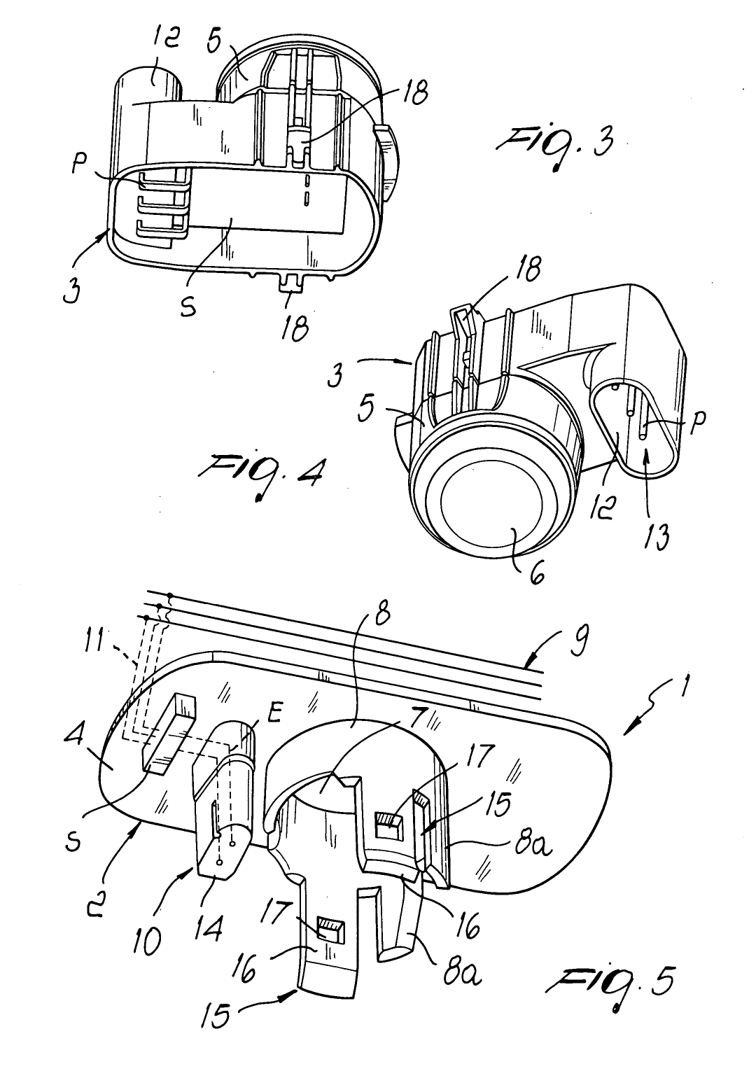

According to the present invention, the electronic boards S can be arranged inside and/or outside the devices 3; FIGS. 1 to 4, for example, illustrate a first embodiment of the unit 1, in which they are accommodated inside the devices 3 and are interposed between the sensors 6 and the corresponding connection ports P.

In this embodiment, each circuit 11 of the connection means 10 is formed inside the body 14, and when the corresponding device 3 is positioned in the assembly configuration it can be placed in direct contact with the connection port P.

In a second embodiment of the unit 1, shown in FIG. 5, the electronic boards S are external to the devices 3 and are arranged on the supports 2 so as to connect, in the assembly configuration, the connection ports P of the devices 3 to the corresponding circuits 11.

In greater detail, in this second embodiment the electronic boards S are interposed between the circuit 11 and an electrical connection E, which is formed inside the body 14 and is designed to be placed in contact with the connection ports P, which in practice are adapted to transmit the signal acquired by the sensors 6 and the power supply current that arrives from the electronic boards S.

The most suitable choice among the illustrated embodiments is performed according to construction parameters to be assessed in each case, such as for example the overall dimensions of the unit 1.

Conveniently, in the assembled configuration, the devices 3 are rigidly associated with the supports 2 by way of temporary fixing means 15.

In the embodiment of the unit 1 shown in the figures, the fixing means 15 are of the snap-acting type and comprise two elastic wings 16, which protrude from each hollow cylinder 8 substantially at right angles to the plate 4 and are provided with a respective transverse hole 17, suitable to be engaged by a corresponding retention tooth 18 formed on the lateral surface of the device 3.

Preferably, the conducting cables 9 are rigidly fixed to the bumper, for example during its production; moreover, at one of their ends they are associated with the circuit 11 of each support 2, and at their other end they are wired together so as to provide a single output to be connected to the control unit of the vehicle.

In practice it has been found that the described invention achieves the proposed aim and object, and in particular the fact is stressed that it allows to reduce the time required to fit the devices to the bumper and consequently also reduces the associated labor costs.

It is in fact noted that the particular embodiment of the sensing device according to the invention, in which the connection port and the portion designed to locate the obstacles are oriented in the same direction, allows to fit each device to the bumper and to connect it to the conducting cables by performing a single operation; moreover, the connection of all the devices to the control unit by means of a single coupling of said cables to said control unit is particularly straightforward and simple.

The invention thus conceived is susceptible of numerous modifications and variations, all of which are within the scope of the appended claims.

In practice, the materials used, as well as the contingent shapes and dimensions, may be any according to requirements without thereby abandoning the scope of the protection of the appended claims.

The disclosures in Italian Patent Application No. MO2004A000005 from which this application claims priority are incorporated herein by reference.

1. A unit for sensing obstacles in the vicinity of vehicles, comprising at least one support, which can be associated with the body of a vehicle, and at least one obstacle sensing device, which can be connected to a processing unit by way of the interposition of electronic transmission means, wherein said support comprises means for electronic connection of said sensing device to said transmission means.

2. The unit according to claim 1, wherein said support is associable with the bumper of said vehicle.

3. The unit according to claim 2, wherein said support comprises at least one plate, which is associable with the internal surface of said bumper.

4. The unit according to claim 3, wherein said plate and said bumper are provided with a respective through opening, said openings being adapted to be arranged so as to substantially mate so as to allow the insertion of said sensing device in an assembly configuration, in which at least one portion of said sensing device faces outward and is provided with obstacle sensing means.

5. The unit according to claim 4, wherein said sensing means are of the type of sensors, transducers, microcameras or the like.

6. The unit according to claim 4, wherein said sensing means comprise at least one ultrasonic sensor.

7. The unit according to claim 4, wherein said connection means comprise an electronic circuit, which is associable with said transmission means and is adapted, in the assembly configuration, to be connected to a connection port of said sensing device.

8. The unit according to claim 7, wherein said connection port and said portion of the sensing device are both oriented toward said plate, the insertion of said sensing device in the opening of said plate being adapted to connect said connection port to said circuit.

9. The unit according to claim 3, wherein said connection means comprise at least one elongated body, which protrudes from the surface of said plate that lies opposite said bumper, said body being arranged, in the assembly configuration, so that it is inserted in a cavity formed in said sensing device at said connection port.

10. The unit according to claim 7, further comprising at least one electronic board for processing a signal acquired by said sensing means, said board being interposed between said sensing means and said circuit.

11. The unit according to claim 10, wherein said board is accommodated inside said sensing device and is interposed between said sensing means and said connection port.

12. The unit according to claim 10, wherein said board is external to said sensing device and is interposed between said connection port and said circuit in said assembly configuration.

13. The unit according to claim 10, wherein said circuit is provided inside said elongated body.

14. The unit according to claim 3, further comprising means for fixing said sensing device to said support.

15. The unit according to claim 14, wherein said fixing means are of the temporary type.

16. The unit according to claim 14, wherein said fixing means are of the snap-acting type.

17. The unit according to claim 14, wherein said fixing means comprise at least one elastic wing that protrudes from said plate and is provided with at least one respective hole that is adapted to be engaged by a corresponding retention tooth that is provided on said sensing device.

18. The unit according to claim 2, wherein said support is associable with said bumper by interposing anchoring means.

19. The unit according to claim 18, wherein said anchoring means are of the snap-acting type or of the threaded type.

20. The unit according to claim 2, wherein said support is associable with said bumper by gluing or welding.

21. The unit according to claim 3, wherein said support is built into said bumper so as to constitute a single body with it, said plate being formed by at least one portion of said bumper.

22. The unit according to claim 2, wherein said transmission means are rigidly associated with said bumper.

23. The unit according to claim 1, further comprising a plurality of said sensing devices.

24. The unit according to claim 1, wherein said transmission means comprise a plurality of conducting cables, which are associated at one end with the means for connecting said sensing devices and are wired together at the other end.
